(19) United States
(12) Patent Application Publication
(10) Pub. No.: US 2014/0103945 A1
(43) Pub. Date: Apr. 17, 2014

(54) APPARATUS AND METHOD FOR DEMONSTRATING QUANTIZED CONDUCTANCE

(71) Applicant: Miami University, Oxford, OH (US)

(72) Inventors: Khalid Fatthi Eid, Oxford, OH (US); Robert Douglas Tolley, Montgomery, OH (US)

(21) Appl. No.: 14/047,586

(22) Filed: Oct. 7, 2013

Related U.S. Application Data
(60) Provisional application No. 61/710,012, filed on Oct. 5, 2012.

(51) Int. Cl. G01N 27/04

(52) U.S. Cl. CPC G01N 27/041
USPC 324/693

(57) ABSTRACT

A lab experiment device and method that demonstrate quantized conductance as a macroscopic gold wire is elongated and broken. The device utilizes a mechanically controlled break junction to demonstrate conductance quantization. A preferred assembly includes a rigid plate with a block to which a micrometer mounts. Spaced posts are mounted to the plate forming a gap between the posts and the block, and a flexible beam is seated against the posts with the anvil of the micrometer seated against the beam. A wire that is mounted to the beam elongates when the anvil forces the beam into a bending configuration. By passing current through the wire and detecting the voltage through a constriction formed in the wire, one can witness conductance quantization as the wire elongates at the constriction to form a conductor of one atom.

### CROSS-REFERENCES TO RELATED APPLICATIONS

This application claims the benefit of U.S. Provisional Application No. 61/710,012 filed Oct. 5, 2012. This prior application is hereby incorporated by reference.

### STATEMENT REGARDING FEDERALLY-SPONSORED RESEARCH AND DEVELOPMENT

(Not Applicable)

### THE NAMES OF THE PARTIES TO A JOINT RESEARCH AGREEMENT

(Not Applicable)

### REFERENCE TO AN APPENDIX

(Not Applicable)

### BACKGROUND OF THE INVENTION

The invention relates generally to equipment for scientific experiments, and more particularly to equipment for experimenting to demonstrate the properties of conductors.

In recent decades there has been an enormous surge of interest in nanotechnology and nanoscience. This interest has been fueled by predictions that nanotechnology will have a significant and broad impact on many aspects of the future, including technology, food, medicine, and sustainable energy. Many universities in the U.S.A. and around the world started to establish programs teaching nanotechnology in order to produce the necessary nano-scale skilled workforce and to inform the public about nanotechnology's potential benefits and environmental risks. Nanoscale science and technology programs have even been utilized to sustain low-enrollment physics programs and to reform the Science, Technology, Engineering, and Mathematics (STEM) focus.

Because of this evolution, it is necessary to devise more experiments and develop curricula that will motivate the field properly and give students a good appreciation and basic understanding of the nano-scale. Several core concepts have been identified as fundamental to student understanding of phenomena at the nano-scale. Two such concepts are the importance of quantum mechanics and the understanding of the sizes and scales at which interesting phenomena occur. Quantum mechanics shows that when matter is confined at the atomic scale, it can have quantitatively and qualitatively different properties than at the macroscopic scale. One consequence of this confinement and the particle-wave duality is the quantization of electrical conductance, where the classical electron transport properties and the well-established Ohm's Law cease to apply.

The simple classical model known as the Drude model, assumes that conduction electrons in a metal move freely and randomly in all directions within the metal, just like atoms move in an ideal gas, as depicted by the solid blue arrows in FIG. 1. The ‘thermal’ speed of electrons depends on the temperature and is given by:

$$〈 v 〉 = \sqrt{\frac{8 {k}_{B} T}{π m}} ,$$

where m is the electron mass, <v> the average speed, and k_{B} the Boltzmann constant.

The average distance that an electron travels before it scatters is known as the mean-free-path (l) and the net velocity of an electron in the absence of external forces is zero because electrons move randomly in all directions. When a potential difference (V) is applied across a wire, it produces an electric field (E) and a force (F) acting on the electrons in the opposite direction to the field. So, an electron will accelerate during its travel between collisions according to Newton's law: \vec{F}=m\vec{a}=−e\vec{E} and its speed after time (t) from being scattered is given by:

$${v}_{2} = {v}_{0} + \frac{e Et}{m} .$$

When this is averaged over the time between collisions, one obtains the drift velocity (v_{d}):

$${v}_{d} = \frac{e E τ}{m} , \qquad ( Equation 1 )$$

where τ is the average time between collisions.

As shown in FIG. 1, in the absence of electric fields electrons move randomly in all directions (solid lines) having a net velocity equal to zero. When a field is applied electrons accelerate in the opposite direction to the field (dotted curves) and there will be a net drift velocity opposite to the field. This drift is what produces the electric current. The effect of the electric field on electron paths is depicted in the dotted arrows shown in FIG. 1. The curvature in the arrows is not to scale because the thermal speed of the electrons is usually a usually about 10 orders of magnitude higher than the net drift velocity.

The electric current (I) through a wire with cross sectional area (A) is (as illustrated schematically in FIG. 2):

$$I = \frac{Δ Q}{Δ t} = e {NAv}_{d} . \qquad ( Equation 2 )$$

Substituting Equation (1) in Equation (2) leads to the usual form of Ohm's law:

$$J = \frac{{e}^{2} NE τ}{m} = σ E , \\ where \\ σ = \frac{{e}^{2} N τ}{m} \qquad ( Equation 3 )$$

is the conductivity (which is an ‘intrinsic’ property of the material that does not depend on the geometry), J is the current density, and N the number density of free electrons in the metal.

$$G = \frac{σ A}{L} .$$

The conductance (G) of the wire of length (L) is then given by: This simple classical treatment works reasonably well and needs only two quantum mechanical corrections (i.e. replacing v_{d} by the Fermi velocity, V_{F}, and treating the electron as a wave, rather than a hard sphere) to yield the correct values of a for macroscopic metals. But this treatment fails when the sample size is small, comparable to the mean-free-path (l) of the electrons carrying the charge, where the conductance becomes independent of the sample length and varies in discrete steps rather than being continuous.

If a macroscopic wire has a constriction of width (w) and length (L) in it, then the proper understanding and calculation of the conductance depends on the relative sizes of w and L to the mean-free-path and the de Broglie wavelength, λ_{F}, of the electrons in the wire. More specifically, there are three limits that produce different conduction properties across the constriction: w,L>>l, L<l, and w≈λ_{F}. These three limits are discussed below.

The Classical Limit.

FIG. 3 shows a wire with a constriction of width (w) and length (L) much larger than the mean free path (l) of the metal. In this case, an electron traveling through the constriction will scatter many times before it reaches the other end of the wire. Since the wire is a metal there will be no charge accumulation anywhere within the constriction and the Laplace equation ∇²V(x,y,z)=0 applies. The conductance can be shown to be:

G=wσ (Equation 4).

Equation (4) shows that the conductance is a smooth function of the radius of the constriction in the classical limit, which applies to macroscopic conductors.

The Semi-Classical Limit.

When the constriction length is less than 1, the transport of electrons through it will occur without any scattering and electrons will accelerate without losing any of their momentum in the constriction, as shown in FIG. 4. This is known as ballistic transport. The model of this limit is a mixture of concepts from quantum and classical mechanics and it is called the semi-classical limit. The conductance in this limit is known as the Sharvin conductance and is given by:

$$G = \frac{2 {e}^{2}}{h} {( {k}_{F} w )}^{2} ,$$

where h is the Planck constant and k_{F} is the wave vector at the Fermi energy. The conductance of the constriction in this limit is independent of the conductivity of the constriction material and increases quadratically with its width.

The Quantum Limit.

As the constriction radius shrinks further and gets down to the atomic scale, the constriction radius will be comparable to the de Broglie wavelength of the electrons, w≈_{F}. At this point, a full quantum mechanical treatment is needed to understand the behavior. The hallmark of this transport limit is that the conductance will be quantized. If the constriction is modeled to be very long in the x-direction, which is the direction of motion of the electrons down the length of the wire, and there is a small width (w) in the radial direction, then this radial confinement will cause the motion in the radial direction to be quantized, allowing only a finite number of wavelengths or ‘conduction channels’ in that direction (see FIG. 5). The x-motion will still be continuous. Thus, the number of conduction channels in the constriction is limited, just like in a one-dimensional quantum well of width w, where:

$${λ}_{n} = \frac{h}{{P}_{n}} = \frac{2 w}{n} ,$$

where Pₙ and λn are, respectively, the momentum and the de Broglie wavelength of an electron in quantized level n.

If we consider all the states below the Fermi energy to be occupied and all the states above it to be empty, then the shortest de Broglie wavelength is fixed at the Fermi wavelength given by:

$${λ}_{F} = \frac{h}{\sqrt{2 m {ɛ}_{F}}} ,$$

where εF is the Fermi energy. So, the number of conduction channels (n) depends directly on the width (w):

$$n = \frac{2 w}{{λ}_{F}} .$$

As the width of the constriction becomes smaller, the number of allowed channels decreases in integer steps, due to the quantization of the allowed wavelengths. When there is one atom at the constriction, the width (˜0.25 nm) becomes equal to half the Fermi wavelength (˜0.5 nm) and only one conduction channel is allowed. When a voltage (V) is applied across the constriction, the magnitude of the current for a single conduction channel (k) is given by

Iₖ=2e∫₀^{∞}vₖ(ε)(ρ_{KL}(ε)−ρ_{kR}(ε))dε (Equation 5),

where vₖ is the Fermi velocity of electrons in channel (k), the number 2 is due to the spin degeneracy, c is the energy, L and R refer to the left and the right sides of the constriction, and ε is the one dimensional density of states:

$$ρ = \sqrt{\frac{m}{2 {h}^{2} ɛ}} = \frac{1}{hv}$$

for ε<ε_{F} and ρ=0 for ε>ε_{F}. The above integral is zero except in the range

$${ɛ}_{F} - \frac{eV}{2} to {ɛ}_{F} + \frac{eV}{2}$$

(or just 0 to eV), because the density of states on one side is zero and is nonzero on the other side in that case.

Therefore, the net current is:

$${I}_{k} = 2 e {\int }_{0}^{eV} {v}_{k} ( \frac{1}{{hv}_{k}} - 0 ) d ɛ = 2 \frac{{e}^{2}}{h} V . \qquad ( Equation 6 )$$

Equation (6) gives the quantized conductance per channel as:

$${G}_{k} = 2 \frac{{e}^{2}}{h} .$$

This is twice the fundamental unit of conductance (due to spin degeneracy), and is independent of material properties and geometry. For an integer number (n) of channels:

$${G}_{n} = 2 \frac{{e}^{2}}{h} n . \qquad Equation ( 7 )$$

So, as the constriction narrows, the number n of available channels decreases by integer steps giving rise to the quantized conductance effect Gₙ.

The demonstration of this effect has historically been carried out on expensive equipment, thereby limiting the number of students who can view the results of this experiment.

### BRIEF SUMMARY OF THE INVENTION

Applicants have developed an inexpensive and robust device and method that can be used in a laboratory experiment on conductance quantization as an example of the emergence of new behavior at the nano-scale. The device employs a technique based on the Mechanically Controlled Break Junction (MCBJ) to form an atomic-scale constriction in a gold wire. The gold wire has a weak point, and the ductile nature of the gold in the wire allows the constriction (weak area) to reduce in diameter by stretching the wire until there are a few atoms left at the constriction. A single-atom chain then forms just before the wire breaks. By conducting electricity through the gold wire and measuring the voltage across the wire, the quantization of conductance can be observed. This process can be repeated as many times as desired using the same wire, since the nature of gold allows the wire to reconnect and break again easily and repeatedly.

While conductance quantization experiments have been performed using far more expensive and significantly different equipment, the device and method of the invention are unique in at least as much as they do not require expensive equipment (requiring advanced lithography), yet give excellent reproducibility and control of the breaking and reconnecting of the conductor. It also costs much less to make the samples and uses a simpler measurement setup. The experiment helps students understand that confinement at the nano-scale leads to observable quantum mechanical effects. Also, the different transport and scattering regimes can serve as natural “milestones” in appreciating the size scales involved in reducing a conductor's dimensions from the macro- to the nano-scale.

Previous experiments have used tapping on a table to connect and disconnect two separate, but touching, gold wires, among other approaches, and they display quantized conductance steps. Another recent experiment used MCBJs to demonstrate conductance quantization in a public exhibit. However this experiment required deep ultraviolet (UV) lithography or electron beam lithography to make the break junctions. The fabrication requirement makes such an approach difficult to adopt in most physics labs that do not have extensive nano-fabrication capabilities. It is also known to have a relatively inflexible crystal with gold deposited on it by vapor deposition in a few atom layers, and then bend this structure, but this is already a conductor having thickness at the atomic level.

The MCBJ setup disclosed herein offers better stability as well as control over the breaking and reconnecting of the gold wire. A conductance step may last for tens to hundreds of milliseconds at a time in the MCBJ assembly according to the present invention, rather than microseconds as in the prior art. Furthermore, the inventive resistance measurement assembly is much simpler and more direct, making its approach more suited to educational purposes.

Another pedagogical advantage of the inventive method and device is that by not using advanced lithography, students are not distracted from appreciating the different size scales that are spanned by the shrinking constriction radius. The entire experiment occurs before students' eyes, the break junctions are made from macroscopic wires and the setup is very simple, inexpensive and accessible for students in advanced physics and/or engineering as well as nanoscience programs. Each sample is inexpensive and can be used repeatedly.

In general, the invention contemplates a very flexible (under elastic deformation) beam with a conductive (preferably gold) wire mounted on the beam. The wire is preferably of a macro size, meaning it is greater than about one micron in diameter. The beam is contacted by a micro-adjustable prime mover, such as a mechanical micrometer, at an angle that, during movement by the prime mover, causes bending of the beam. Preferably the angle of contact is equal to, or approximates, about ninety degrees. The bending of the beam is preferably focused on the section of the beam to which the wire is attached, and at which the wire has a constriction.

By thereby bending the beam slowly at the constriction, a large amount of movement of the prime mover, such as one micron, causes the same amount of bending of the beam, and gives excellent control over the amount which the wire is elongated, such as 50 nanometers. This causes a small and controllably increased amount of elongation of the wire at the constriction as the beam bends and the wire elongates due to attachment to the beam. Using this setup, a micro-adjustable prime mover can cause very small elongations of the wire at the constriction, which focuses the elongation of the wire and causes the elongation to proceed at a highly controllable rate. This focusing allows the wire to draw to a narrowed portion that becomes approximately one atom in width at the limit prior to breaking.

In a preferred embodiment, a rigid plate is disposed with two spaced posts mounted transversely and rigidly to the major plane of the plate. A block is mounted to one face of the plate at a distance from the two posts, with a micro-adjustable prime mover (such as micrometer or a piezo-electric crystal) with its moveable finger extending through the block toward the space between the two posts. The beam is suspended between the two posts with the wire on the opposite side of where the moveable finger contacts the beam so that the finger impacts the beam near where the wire is attached. A current is conducted through at least the constriction of the wire, such as by connecting a conventional D-cell battery's terminals to opposite ends of the wire. A conventional D-cell battery works well because there is little noise, but it is not the only current source that can be used. The electrodes of a sensor, such as a conventional voltmeter, are also attached to the wire on opposite sides of the constriction. The voltage across the wire and through the constriction is sensed by the voltmeter.

Upon movement of the finger, the beam is bent between the two posts, and the wire elongates due to the bending. Thus, the electrical current passing through the wire is affected by quantization at the limit of elongation of the wire at the constriction. As the wire narrows to close to one atom at the constriction, quantization effects are seen in the voltage detected.

The prime mover provides micron-level adjustability in bending the beam, which gives essential control to elongation. Bending of the beam is, in effect, a “gear reduction” feature due to the finger of the micrometer moving at a right angle relative to the axis of the beam. This results in a reduction of about 1/50,000, and therefore when the micrometer moves one micron, the wire is elongated about one-fifty thousandths of a micron, which is about 50 nanometers.

While the electrical current passes through the wire, a conventional voltmeter detects any change in the voltage. It is preferred to connect the volt meter to a computer to take samples many thousands of times per second to obtain a significant base of data. It should be noted that, although the assembly described herein describes a device for pushing the beam to bend it, a person of ordinary skill will know how to modify the assembly to pull the beam and bend it. Furthermore, although a beam is bent as a simple beam between two supports, the beam can be bent in a cantilever fashion.

### BRIEF DESCRIPTION OF THE SEVERAL VIEWS OF THE DRAWINGS

FIG. 1 is a schematic illustrating electric current in metal caused by the flow of free electrons.

FIG. 2 is a schematic illustrating current through a conductor, which is the electric charge that crosses area A per unit second and is the charge density times the volume of the charge that crosses plane A every second.

FIG. 3 is a schematic illustrating that the relative length (L) and width (w) of a constriction to the mean-free-path and the Fermi wavelength determine its conductance properties. In the diffusive regime shown in FIG. 3, electrons scatter many times while in the constriction, so the classical theory describes the transport properties well.

FIG. 4 is a schematic illustrating that the ballistic regime is when the mean-free path is longer than the constriction and no scattering takes place in the constriction area.

FIG. 5 is a schematic illustrating that as the constriction width becomes comparable to the Fermi wavelength, the wave nature of the electrons dominates the transport and only electrons with given wavelengths or channels are allowed to move across the constriction.

FIG. 6 is a view in perspective illustrating the Mechanically Controlled Break Junction (MCBJ) assembly of the present invention showing the pin of the micrometer, the bending beam, the stops and the wire. No solder is needed to connect the ends of the gold wire to the stops.

FIG. 7 is a top view illustrating the MCBJ assembly of FIG. 6 showing the disk used to rotate the micrometer, the battery, the wires, and the bending beam.

FIG. 8 is a top view illustrating a gold wire mounted on a beam, such as a sheet of spring steel, with a quarter dollar coin adjacent it for comparison. There are two epoxy adhesive drops bonding the wire to the beam.

FIG. 9 is a magnified view illustrating the wire of FIG. 8 with adhesive bonding the wire to the beam. The wire is partially cut in the middle to create a weak point in it.

FIG. 10 is a top view illustrating the assembly of FIG. 6.

FIG. 11 is a schematic of a preferred electrical circuit used to measure the conductance of the wire.

FIG. 12 is a screen shot of a computer screen illustrating a program that monitors and records data from the MCBJ assembly.

FIG. 13 is a graph illustrating quantized conductance data obtained from the MCBJ assembly, in particular the voltage across the constriction that varies in a stepwise manner due to the quantized resistance of the constriction. The inset shows the same graph for a smaller voltage range of 0.1V. The voltage step size gets smaller with increasing value of the variable, n.

FIG. 14 is a graph illustrating quantized conductance data obtained from the MCBJ assembly, in particular conductance (in fundamental conductance units) is shown versus time. G is quantized and clear steps are observed at integer values of the variable, n.

FIG. 15 is a graph illustrating quantized conductance data obtained from the MCBJ assembly, in particular several data sets in one graph collected from a single wire. Each of the experiments in the series displays quantized conductance. Time is displayed on a logarithmic scale.

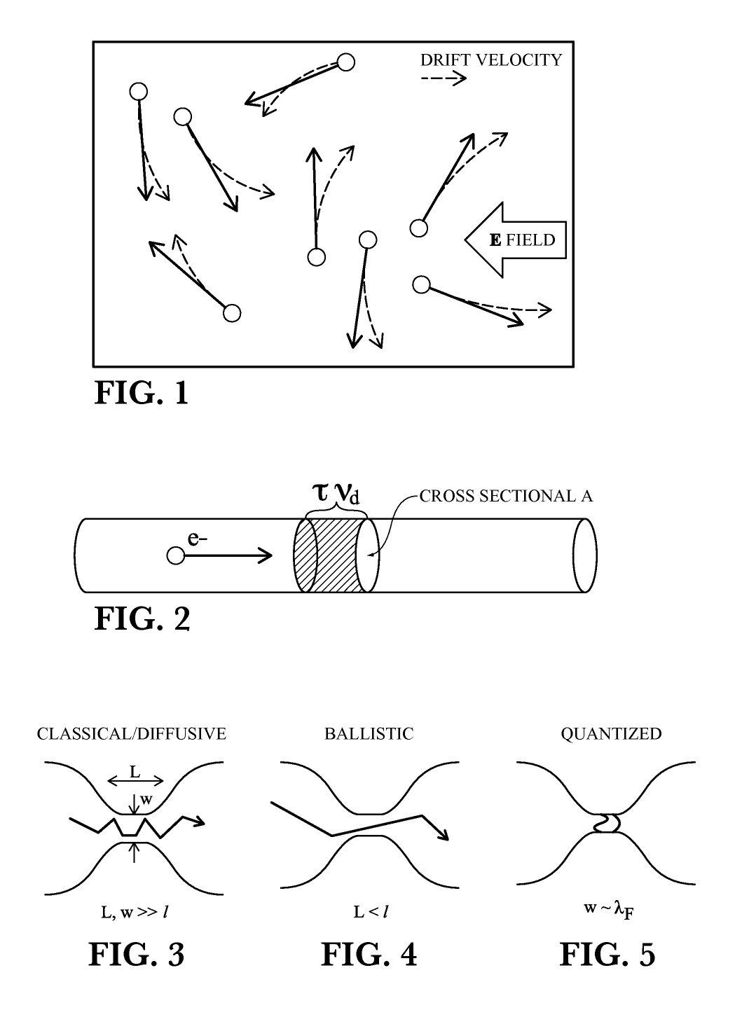

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Patent application Ser. No. 61/710,012 filed Oct. 5, 2012 is incorporated in this application by reference.

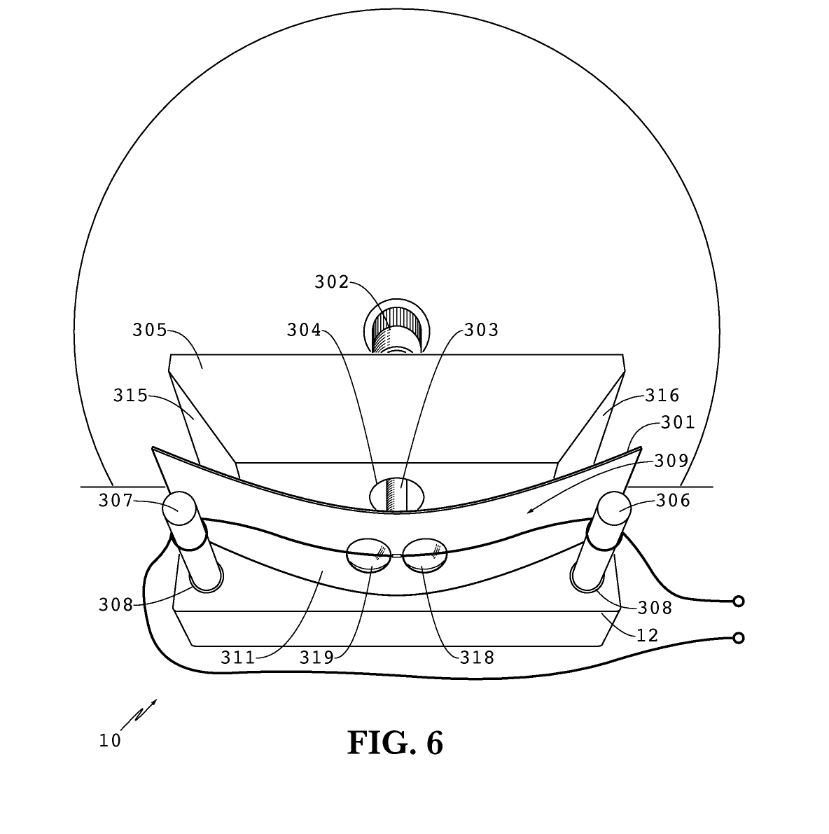

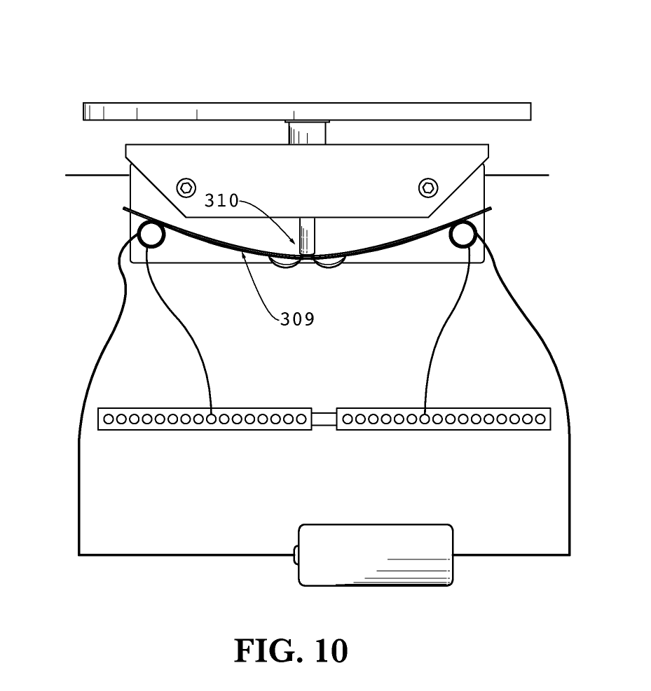

FIGS. 6 through 10 show the preferred assembly 10 that can be used in the experiment described herein. Of course, this assembly is not the only structure that embodies concepts described herein, as will become apparent to the person having ordinary skill from the description herein. Alternative structures and methods are described below, but others will become apparent to the person of ordinary skill from this description. The description of some alternatives does not imply that the description of alternatives herein is exhaustive.

The MCBJ assembly 10 preferably uses a spring steel sheet as a bending beam 301. Of course, any thin, flexible sheet can be substituted for spring steel, and includes plastic, aluminum and composites of glass fibers or carbon fibers in a flexible polymer matrix. The bending beam is preferably electrically non-conductive material, such as stainless steel. The preferred bending beam 301 illustrated is preferably about three inches long, about one-half inch wide, and about 0.008 inches in thickness. The preferred beam bends within a range from about ½ inch to about 1 inch. Of course, other bending beam dimensions and materials can be used with the person of ordinary skill recognizing that a beam made of a material with dimensions that allow significant bending of the beam is the goal. If spring steel sheet or any other electrically conductive material is used as the bending beam 301, a non-conductive coating or layer, such as a thin insulating layer, is preferably applied to the face on which the gold wire 312 is attached as described next.

As shown in FIG. 8, a gold wire 312 is mounted to the bending beam 301 to provide a mechanical attachment that will not be affected by bending of the beam 301. The preferred attachment is two droplets 318 and 319 of insulating epoxy adhesive with a narrow gap 320 between them. Of course, other attachments, including clamps, screws or rivets, can be used, or the wire can be deposited using chemical vapor deposition or other means, directly on the beam so that the atoms of the wire are bonded with the atoms of the beam or an insulating coating. The wire is preferably circular in cross section or has a slightly larger width than thickness, and preferably has a diameter in the range of about 1.0 millimeter. Of course, the wire could be much larger or significantly smaller, but the smallest dimension of the wire is about one micron. The wire is preferably substantially pure or alloy gold, but silver, lead, copper and other metals and alloys can be substituted for the preferred gold material.

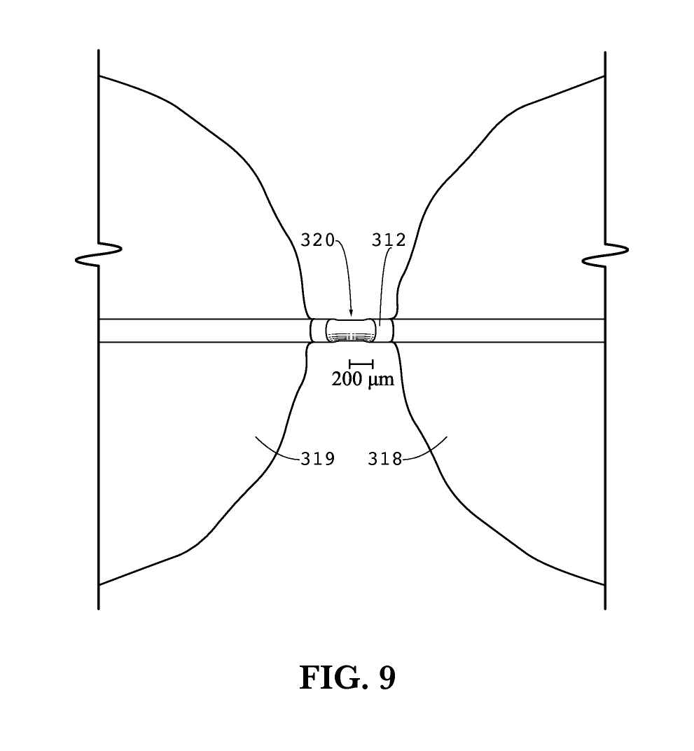

After the epoxy droplets 318 and 319 harden (cure) sufficiently, a sharp blade (not illustrated) is used to cut a shallow notch in the wire 312. If the droplets 318 and 319 merge together, they can be cut as well. The blade can be from a conventional utility knife or another cutting device. The exact type of blade is not critical, but it is important that the blade be capable of cutting a groove in the wire as shown in FIG. 9, which is a scanning electron microscope image of the partly cut wire 312 and the two epoxy drops 318 and 319. As shown, the wire 312 is not completely severed by the knife, but its thickness is substantially decreased in a localized area between the two droplets 318 and 319. Because the tensile strength of an elongated structure tends to be lowest at the narrowest region of the structure, due to tensile strength being a function of cross-sectional area, a ductile gold wire will elongate primarily at the region where the cut is formed and not along the rest of the wire's length. Therefore, a substantial decrease in wire thickness that forms a constriction as the term is used herein is defined as a reduction of thickness sufficient to focus the elongation of the wire at the point of the cut. Contemplated constrictions include decreases by 10 to 90 percent of the thickness of the wire. A decrease that is sufficient for one material might not be for another, as the person of ordinary skill will surmise from the description herein.

The plate 12, which is preferably made of one-half inch thick aluminum, forms a rigid support for the assembly 10. Two preferably cylindrical aluminum stops 306 and 307 are mounted to the plate 12, preferably by extending their ends into bores formed in a major surface of the plate 12. The stops 306 and 307 are spaced apart approximately two and one-half inches on center, and are spaced equally on opposite sides of the bore 304 formed through the main aluminum block 305, which is spaced from the stops 306 and 307.

The conductive stops 306 and 307 are electrically insulated from the main aluminum block 305 by a length of insulating tubing 308 extending around the inserted end of each stop, in order to interpose the insulating material between the stop and the plate 12. The stops 306 and 307 are preferably spaced less than about 3 inches apart, but this distance can be modified, as needed. Furthermore, the angle of the stops relative to the plate, and relative to the block 305, can be modified.

The stops 306 and 307 are positioned so that there is preferably about 2 to 10 mm of distance between the fully retracted anvil tip 310 and a plane that extends across the edges of the stops 306 and 307 closest to the block 305, a plane that preferably contains the beam 301. The sample 311, which is the combination of the beam 301 and wire 312, is placed in the space 309 between the stops 306 and 307 and the block 305, as shown in FIG. 6.

A micrometer 302 is mounted, preferably at the opposite side of the main block 305 from the sample 311, rigidly to the block 305. The anvil 303 of the micrometer 302 passes through the bore 304 formed through the block 305, and the micrometer 302 is secured to the block 305 to provide stability. When fully retracted, the anvil tip 310 is flush with the face of the aluminum block 305 closest to the beam 301. The anvil tip 310 is the terminal portion of the micrometer's moveable finger that advances due to rotation of the micrometer's conventional “thimble” (not visible) so that the tip 310 can make contact with the sample 311.

The frame of the micrometer 302 is mounted to the block with the finger 303 extending through the bore 304 formed in the block 305. Upon rotation of the thimble, the finger 303 extends through the bore and the tip 310 seats against the beam 301. Upon further rotation of the thimble, the finger 303 extends farther, which causes further bending of the beam 301, as described in more detail below.

The micrometer 302 extends with micron-level (i.e., within one to two microns) of displacement accuracy due to human movement of the thimble. The assembly 10 can, of course, instead use a piezoelectric crystal and a micrometer or screw, in which the micrometer or screw is used for coarse motion control and the piezoelectric crystal is used for fine motion control by controlling the crystal electrically manually through a computer, or automatically using a pre-programmed computer. Any micron-level prime mover can be used in place of the micrometer 302 shown and described herein.

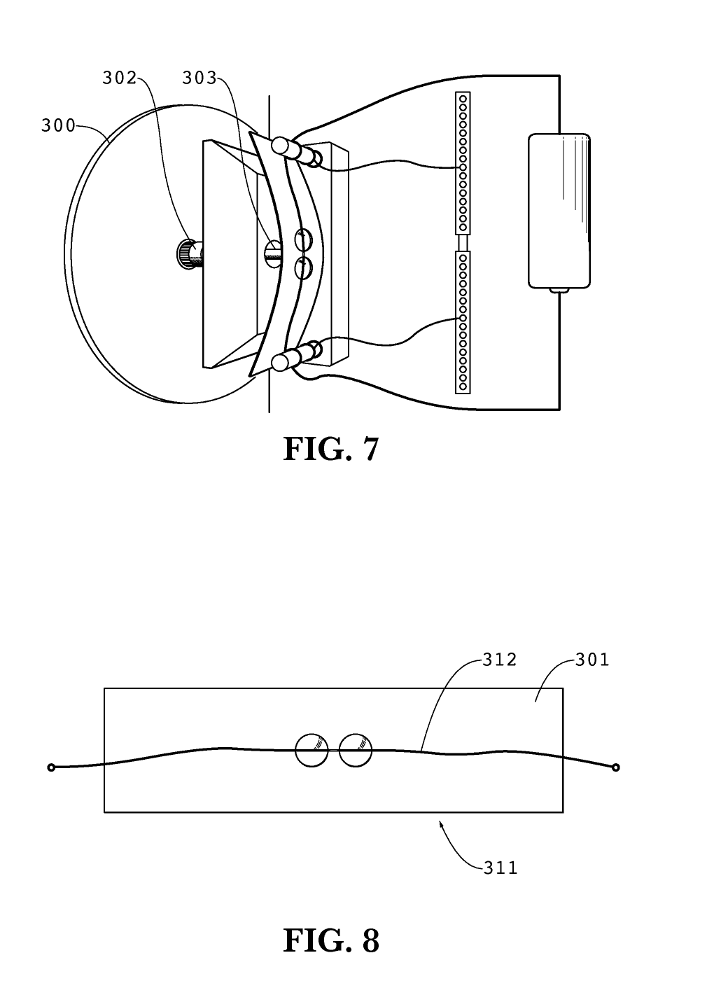

The thimble of the micrometer 302 is preferably rotated manually by a disk 300 (see FIG. 7) that is attached to the thimble. The disk is preferably rigid plastic and has a radius of about five inches. Of course, the material of which the disk 300 is made, and the size of the disk, can be modified with known effects. By mounting the large diameter disk 300 to the thimble, excellent tactile control is given to a human user who rotates the disk 300 to displace the finger 303 and thus bend the beam 301.

During use, the finger 303 of the micrometer 302 is secured in place with its tip 310 against the sample 311. Then the tip 310 is extended and retracted by rotating the disc 300, such as by using a human hand. As the tip 310 extends, it presses into the middle of the bending beam 301, which bends the bending beam 301 outward against the two stops 306 and 307, thereby producing the desired bending motion that elongates the wire 312 on the opposite face from where the tip 310 seats. If the sample 311 is particularly long, as it bends the ends of the bending beam 301 may approach the aluminum block 305, but contact is preferably prevented by cutting two clearance notches 315 and 316 on either side of the block 305.

When the beam bends as described herein, the wire 312, which is spaced a non-trivial distance from the neutral plane of the bending beam 301 elongates. When the beam 301 bends, the wire 312 elongates due to the tensile forces applied to the wire. This elongation causes the wire to neck down once the elastic limit of the wire 312 at the constriction has been reached. Further elongation from this point causes further reduction in cross section at the constriction, until only about one atom bridges across the constriction.

When turning the plastic disk 300 of the micrometer 302 as described above, the wire 312 stretches extremely slowly with a reduction factor (f) given by:

$$f = 3 \frac{ys}{{u}^{2}} ,$$

where y is the distance between the two epoxy drops, s the thickness of the spring steel sheet and the insulating film, and u is the separation between the two stopping edges. It is estimates that f˜2×10⁻⁵ (corresponding to a mechanical reduction of about 50,000), which gives atomic scale motion, when multiplied by the micrometer resolution of about 1 μm. The huge reduction in the bending beam is an important factor in achieving atomic scale motion using the assembly 10, and to eliminate the effect of external vibrations on the assembly 10.

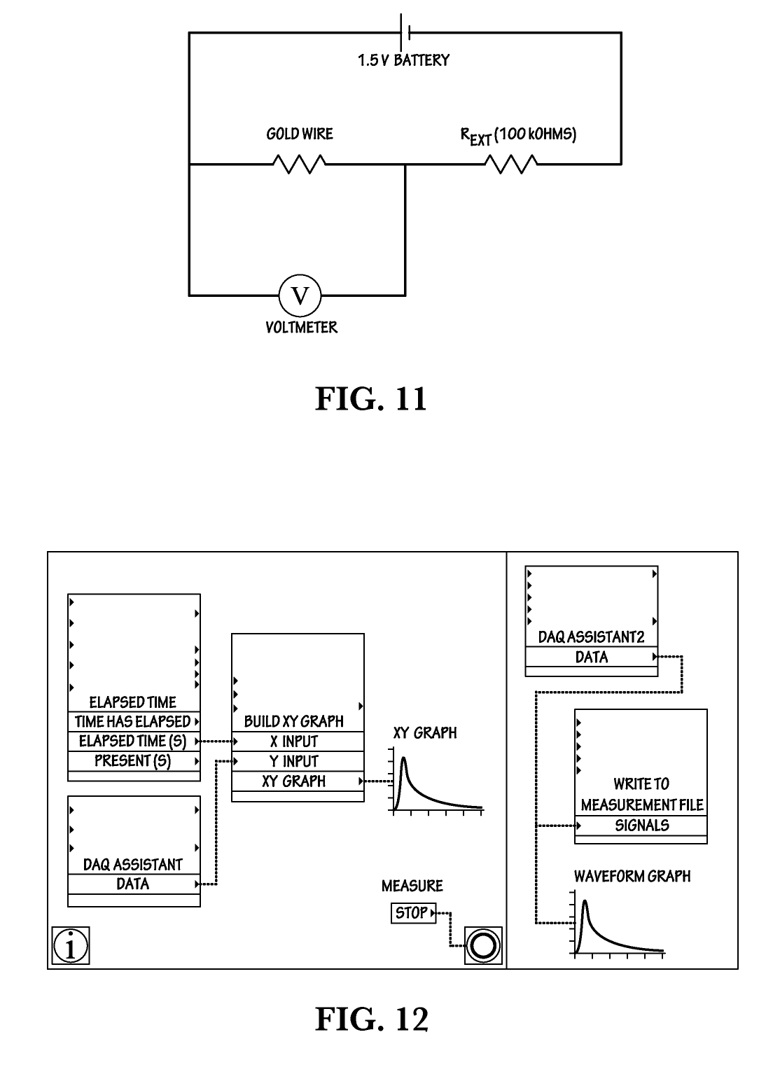

The current through the constriction is produced by connecting the wire 312 in series to an external resistor and a battery as illustrated in a contemplated circuit diagram of FIG. 11. As the wire 312 is elongated by turning the disk 300, the voltage across the wire is measured repeatedly at a high rate (such as at about 10,000 samples per second) using a conventional voltmeter and data acquisition system. The circuit diagram shown in FIG. 11 is but one contemplated system for providing a current source on both sides of the constriction of the wire 312 and a sensor to measure the conductance characteristics (such as the voltage) across the constriction. A contemplated screen shot from a computer program used to collect the data is shown in FIG. 12 as an example of the display of data that is contemplated. Other software can be used to collect the data, as long as it has a high enough acquisition rate.

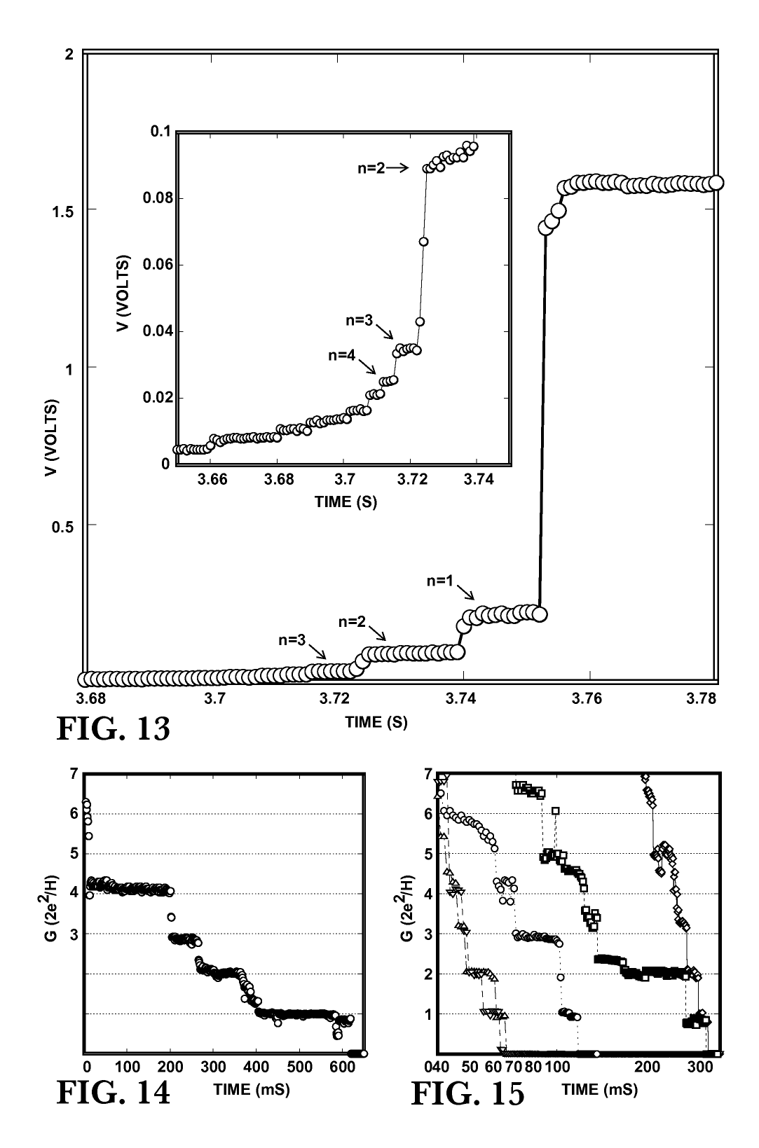

Starting with the unbroken wire 312, the plastic disc 300 is rotated slowly, thereby turning the attached micrometer 302. As the wire 312 stretches at the constriction, the wire's diameter shrinks at the constriction and the voltage across the wire 312 rises continuously because the wire resistance increases with decreasing diameter. When the constriction diameter becomes comparable to the de Broglie wavelength of the electrons (the Fermi wavelength), the voltage displays discrete steps rather than a smooth increase. FIG. 13 shows the voltage variation with time as the wire is being stretched until it breaks. Because the wire 312 is connected in series to the external resistor of, in this example 100 kΩ (which can be modified), the voltage across the constriction is:

$${V}_{w} = {IR}_{w} = \frac{{V}_{B}}{{R}_{w} + {R}_{ext}} {R}_{w}$$

and the conductance is

$$G = \frac{{V}_{B} - {V}_{w}}{{V}_{w} {R}_{ext}} . \qquad ( Equation 8 )$$

Here, V_{B} is the battery voltage, Rₑₓₜ is the external resistor, and R_{w} is the resistance of the wire (i.e. the constriction). FIG. 14 is a plot of G in units of

$$2 \frac{{e}^{2}}{h} .$$

It is clear that G decreases continuously as the wire stretches, and then starts making quantized jumps that coincide with integer values of n.

With the use of a spring steel or other extremely flexible beam with a macro-level thickness wire mounted to it, the beam can be bent substantially to elongate the wire substantially. When one bends the beam 301, all of the elongation is focused at the weak point, which is the constriction, rather than elongating the whole wire 312. The user can thus elongate the preferably gold wire 312, which is extremely ductile, a significant amount by focusing the tensile force on the weakest point.

FIG. 15 shows multiple conductance measurement runs taken on the same wire that broke and reconnected several times. Quantization of the conductance and the reproducibility of the results are clearly visible.

A mechanically simple and robust assembly is herein disclosed to demonstrate and measure the quantized conductance in an atomic scale constriction in a macroscopic gold wire. This experiment can be repeated as many times as desired and can be taught as a laboratory experiment.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A conduction measuring apparatus comprising:
(a) a beam that is elastically deformable and seated at least at one point against a body, the beam having first and second opposing major faces;
(b) a conductive wire mounted to the first major face of the beam, the wire having a constriction along its length;
(c) a micro-adjustable prime mover having a moveable finger that extends toward the beam and is configured to contact one of the major faces of the beam and bend the beam in controllably varied amounts;
(d) a source of current connected to the wire on both sides of the constriction; and
(e) a sensor contacting the wire on both sides of the constriction for detecting the conductive characteristics of the wire through the constriction.

2. The apparatus in accordance with claim 1, wherein the constriction is disposed between two points of attachment to the beam.

3. The apparatus in accordance with claim 2, wherein the two points of attachment to the beam further comprise adhesive bonding the wire to the beam.

4. The apparatus in accordance with claim 1, further comprising a rotatable wheel mounted to the micro-adjustable prime mover, the wheel being configured for manual rotation by a user's hand to thereby effect movement of the moveable finger.

5. The apparatus in accordance with claim 1, wherein the beam is seated against first and second posts that are spaced from one another and spaced from the finger, the first major face of the beam seats against the posts, and the finger seats against the second major face of the beam.

6. A conduction measuring apparatus comprising:
(a) a rigid plate having opposing first and second major faces;
(b) first and second spaced posts extending transversely from the first major face of the rigid plate;
(c) a block mounted to the first major surface of the rigid plate, the block spaced from the first and second posts;
(d) a flexible, elastically deformable beam seated against the first and second posts between the block and the posts, the beam having first and second opposing major faces;
(e) a conductive wire mounted to the first major face of the beam, the wire having a constriction along its length;
(f) a micro-adjustable prime mover mounted to the block and having a moveable finger that extends from the block toward the beam and contacts the beam for bending the beam in controllably varied amounts;
(g) a source of current connected to the wire on both sides of the constriction; and
(h) a sensor contacting the wire on both sides of the constriction for detecting the conductive characteristics of the wire through the constriction.

7. The apparatus in accordance with claim 6, wherein the first major face of the beam seats against the first and second posts, and the moveable finger seats against the second major face of the beam.

8. The apparatus in accordance with claim 7, wherein the micro-adjustable prime mover is a micrometer with a rotatable thimble that displaces an anvil, and a tip portion of the anvil comprises the finger.

9. The apparatus in accordance with claim 8, wherein a wheel is mounted to the rotatable thimble, the wheel being configured for manual rotation by a user's hand to thereby effect movement of the moveable finger.

10. The apparatus in accordance with claim 9, wherein a side of the block that faces the posts has angled walls that accommodate ends of the beam when the beam is bent to an extreme.

11. A method of testing conduction through an electrical conductor, the method comprising:
(a) seating a beam that is elastically deformable against at least one point of a body, the beam having first and second opposing major faces;
(b) mounting a conductive wire to the first major face of the beam;
(c) disposing a micro-adjustable prime mover's moveable finger in contact with the beam;
(d) displacing the moveable finger and thereby bending the beam in controllably varied amounts; and
(e) passing current through the wire.

12. A method in accordance with claim 11, further comprising:
(a) forming a constriction along the length of the conductive wire; and
(b) detecting the conductive characteristics of the wire through the constriction while current is passing through the wire.

13. A conduction measuring apparatus comprising:
(a) a rigid plate having opposing first and second major faces;
(b) first and second spaced posts extending transversely from the first major face of the rigid plate;
(c) a block mounted to the first major surface of the rigid plate, the block spaced from the first and second posts;
(d) a micro-adjustable prime mover mounted to the block and having a moveable finger that extends from the block toward a gap between the posts;
(e) a source of current adjacent the posts; and
(f) a sensor adjacent the posts.

14. The apparatus in accordance with claim 13, further comprising
(a) a flexible, elastically deformable beam seated against the first and second posts between the block and the posts, the beam having first and second opposing major faces;
(b) a conductive wire mounted to the first major face of the beam, the wire having a constriction along its length; and
wherein the micro-adjustable prime mover's finger contacts the beam for bending the beam in controllably varied amounts.

15. An apparatus for testing electrical conductance, the apparatus comprising a flexible, elastically deformable beam having first and second opposing major faces, the first major face having a conductive wire mounted thereto by two spaced fasteners, wherein a finite span of wire remains between the two fasteners, the wire having a minimal dimension of about one micron.

16. The apparatus in accordance with claim 15, wherein the spaced fasteners further comprise adhesive.
